(19) United States
(12) Patent Application Publication
(10) Pub. No.: US 2026/0168408 A1
(43) Pub. Date: Jun. 18, 2026

(54) SYSTEM AND METHOD FOR DECONGEALING A HEAT EXCHANGER

(71) Applicant: General Electric Company, Evendale, OH (US)

(72) Inventors: Shishir Shah, Mumbai (IN); Hojjat Nasr, West Chester, OH (US); Michael Vadnais, Delafield, WI (US); Ajit Kumar Verma, Bangalore (IN); Ravindra Shankar Ganiger, Bengaluru (IN)

(21) Appl. No.: 19/218,749

(22) Filed: May 27, 2025

(30) Foreign Application Priority Data
Dec. 18, 2024 (IN) 202411100409

(51) Int. Cl. F01D 25/10; F01D 21/00; F01D 25/32

(52) U.S. Cl. CPC F01D 25/10; F01D 21/003; F01D 25/32; F05D 2220/32; F05D 2260/83

(57) ABSTRACT

A system includes a heat exchanger, a heated fluid source, a sensor configured to collect data about a coolant in the heat exchanger, and a decongealing assembly arranged to provide heated fluid from the heated air source to one of the heat exchanger or a location upstream of the heat exchanger based on the data collected by the sensor.

### PRIORITY INFORMATION

The present application claims priority to Indian Patent Application Number 202411100409 filed on Dec. 18, 2024.

### FIELD

The present disclosure relates to a heat exchanger for a gas turbine engine with a third stream.

### BACKGROUND

A gas turbine engine typically includes a fan and a turbomachine. The turbomachine generally includes an inlet, one or more compressors, a combustor, and at least one turbine. The compressors compress air which is channeled to the combustor where it is mixed with fuel. The mixture is then ignited, generating hot combustion gases. The combustion gases are channeled to the turbines which extracts energy from the combustion gases for powering the compressors, as well as for producing useful work to propel an aircraft in flight. The turbomachine is mechanically coupled to the fan for driving the fan during operation.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic view of an exemplary gas turbine engine.

FIG. 2 is a schematic view of an exemplary heat exchanger.

FIG. 3 is a schematic view of an exemplary decongealing assembly for the exemplary heat exchanger of FIG. 2.

FIG. 4 is a schematic view of an outlet manifold of the exemplary heat exchanger of FIG. 2.

FIG. 5 is a schematic view of an outlet manifold of another exemplary heat exchanger.

FIG. 6 is a schematic view of another exemplary decongealing assembly for the exemplary heat exchanger of FIG. 2.

FIG. 7 is a schematic view of another exemplary decongealing assembly for the exemplary heat exchanger of FIG. 2.

FIG. 8 is a schematic view of a vortex tube and eductor assembly of the exemplary decongealing assembly of FIG. 7.

FIG. 9 is a schematic view of another exemplary decongealing assembly for the exemplary heat exchanger of FIG. 2.

FIG. 10 is a block diagram of an exemplary method for decongealing the exemplary heat exchanger of FIG. 2.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

Aviation engines use fluids, such as oil or fuel, as coolants to dissipate heat from engine components, such as engine bearings, electrical generators, and the like. Heat is typically rejected from the coolant to air by heat exchanger assemblies, such as fuel cooled oil coolers or air cooled surface oil coolers, to maintain coolant temperatures at a desired 100° F.<T<300° F., for at least certain coolants. In many instances an environment in which the engine may be operated may be as low as −65° F. When the engine is in an engine shut down occurrence in a low temperature environment, the coolant within the heat exchanger assembly begins to cool and may become very viscous, i.e., the coolant “congeals.” As a result, due to the high viscosity of the coolant, it does not flow through the heat exchanger assembly and requires a lengthy period of time to heat up the coolant to a desired viscosity for flowing through the heat exchanger assembly. Heating the coolant to a desired viscosity is also referred to as “decongealing” the coolant, i.e., reversing the congealing of the coolant and returning the coolant to a more fluid state.

The coolant is “congealed” based on one or more properties of the coolant and/or the heat exchanger. As one example, the coolant is determined to be congealed when a pressure difference between an inlet manifold and an outlet manifold of the heat exchanger exceeds a pressure threshold, indicating that the increased viscosity of the coolant an increased pressure to flow the coolant through the heat exchanger. As another example, the coolant is determined to be congealed when a temperature of the coolant, as measured by a temperature sensor, is below a specified temperature threshold, based on the chemical properties of the coolant. As yet another example, the coolant is determined to be congealed when a viscosity of the coolant, as measured by a viscosity sensor, exceeds a viscosity threshold.

To decongeal the coolant, the heat exchanger of the present disclosure includes a decongealing assembly that provides a heated fluid to the heat exchanger. The heated fluid increases the temperature of the coolant, thereby lowering the viscosity of the coolant. The decongealing assembly uses one or more heated fluid sources, such as a fluid sink, a bleed from an engine component, or a vortex tube and eductor system to generate the heated fluid. The decongealing assembly provides the heated fluid to the heat exchanger by flowing the heated fluid through dedicated bypass channels in the plates of the heat exchanger, heating a coolant line to heat an inlet manifold of the heat exchanger, or impinging the heat exchanger with the heated fluid. By utilizing heated fluid sources present in the engine, the decongealing assembly decongeals the coolant in the heat exchanger without additional heaters, heat pipes, or other dedicated decongealing components.

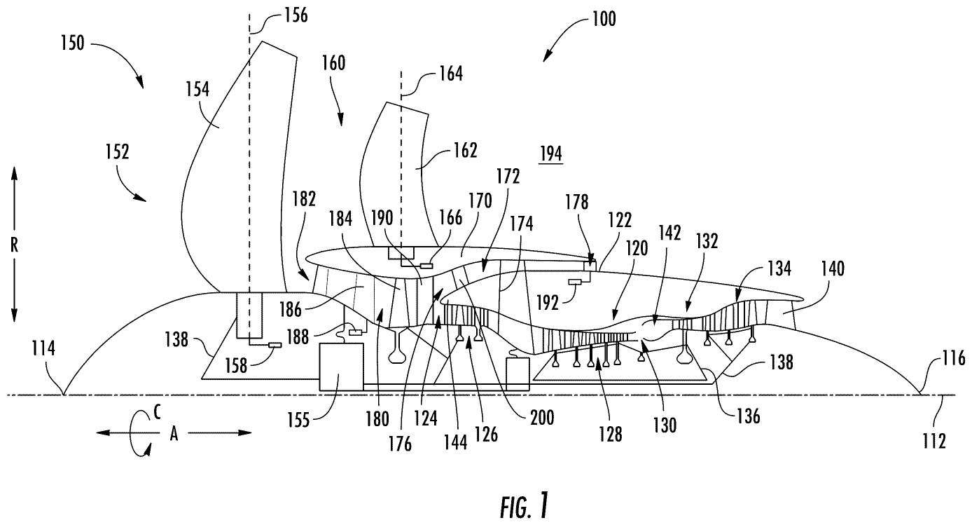

Referring now to the drawings, wherein identical numerals indicate the same elements throughout the figures, FIG. 1 is a schematic cross-sectional view of an engine 100 (e.g., a gas turbine engine) is provided according to an example embodiment of the present disclosure. Particularly, FIG. 1 provides a gas turbine engine having a rotor assembly with a single stage of unducted rotor blades. In such a manner, the rotor assembly may be referred to herein as an “unducted fan,” or the entire engine 100 may be referred to as an “unducted gas turbine engine.” In addition, the engine 100 of FIG. 1 includes a third stream extending from the compressor section to a rotor assembly flowpath over the turbomachine, as will be explained in more detail below.

For reference, the engine 100 defines an axial direction A, a radial direction R, and a circumferential direction C. Moreover, the engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The engine 100 extends between a forward end 114 and an aft end 116, e.g., along the axial direction A.

The engine 100 includes a turbomachine 120 and a rotor assembly, also referred to a fan section 150, positioned upstream thereof. Generally, the turbomachine 120 includes, in serial flow order, a compressor section, a combustion section, a turbine section, and an exhaust section. Particularly, as shown in FIG. 1, the turbomachine 120 includes a core cowl 122 that defines an annular core inlet 124. The core cowl 122 further encloses at least in part a low pressure system and a high pressure system. For example, the core cowl 122 depicted encloses and supports at least in part a booster or low pressure (“LP”) compressor 126 for pressurizing the air that enters the turbomachine 120 through the annular core inlet 124. A high pressure (“HP”), multi-stage, axial-flow compressor 128 receives pressurized air from the LP compressor 126 and further increases the pressure of the air. The pressurized air stream flows downstream to a combustor 130 of the combustion section 120B where fuel is injected into the pressurized air stream and ignited to raise the temperature and energy level of the pressurized air.

It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems, and are not meant to imply any absolute speed and/or pressure values.

The high energy combustion products flow from the combustor 130 downstream to a high pressure turbine 132. The high pressure turbine 132 drives the high pressure compressor 128 through a high pressure shaft 136. In this regard, the high pressure turbine 132 is drivingly coupled with the high pressure compressor 128. As will be appreciated, the high pressure compressor 128, the combustor 130, and the high pressure turbine 132 may collectively be referred to as the “core” of the engine 100. The high energy combustion products then flow to a low pressure turbine 134. The low pressure turbine 134 drives the low pressure compressor 126 and components of the fan section 150 through a low pressure shaft 138. In this regard, the low pressure turbine 134 is drivingly coupled with the low pressure compressor 126 and components of the fan section 150. The LP shaft 138 is coaxial with the HP shaft 136 in this example embodiment. After driving each of the turbines 132, 134, the combustion products exit the turbomachine 120 through a turbomachine exhaust nozzle 140.

Accordingly, the turbomachine 120 defines a working gas flowpath or core duct 142 that extends between the annular core inlet 124 and the turbomachine exhaust nozzle 140. The core duct 142 is an annular duct positioned generally inward of the core cowl 122 along the radial direction R. The core duct 142 (e.g., the working gas flowpath through the turbomachine 120) may be referred to as a second stream.

The fan section 150 includes a fan 152, which is the primary fan in this example embodiment. For the depicted embodiment of FIG. 1, the fan 152 is an open rotor or unducted fan 152. In such a manner, the engine 100 may be referred to as an open rotor engine.

As depicted, the fan 152 includes an array of fan blades 154 (only one shown in FIG. 1). The fan blades 154 are rotatable, e.g., about the longitudinal axis 112. As noted above, the fan 152 is drivingly coupled with the low pressure turbine 134 via the LP shaft 138. For the embodiments shown in FIG. 1, the fan 152 is coupled with the LP shaft 138 via a speed reduction gearbox 155, e.g., in an indirect-drive or geared-drive configuration.

Moreover, the array of fan blades 154 can be arranged in equal spacing around the longitudinal axis 112. Each fan blade 154 has a root and a tip and a span defined therebetween. As will be appreciated, a distance from the base of each fan blade 154 to a tip of the respective fan blade 154 is referred to as a span of the respective fan blade 154.

Moreover, each fan blade 154 defines a central blade axis 156. For this embodiment, each fan blade 154 of the fan 152 is rotatable about their respective central blade axis 156, e.g., in unison with one another. One or more actuators 158 are provided to facilitate such rotation and therefore may be used to change a pitch of the fan blades 154 about their respective central blades' axes 156.

The fan section 150 further includes a fan guide vane array 160 that includes fan guide vanes 162 (only one shown in FIG. 1) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 1 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about its respective central blade axis 164, e.g., in unison with one another. One or more actuators 166 are provided to facilitate such rotation and therefore may be used to change a pitch of the fan guide vane 162 about its respective central blade axis 164. However, in other embodiments, each fan guide vane 162 may be fixed or unable to be pitched about its central blade axis 164. The fan guide vanes 162 are mounted to a fan cowl 170.

As shown in FIG. 1, in addition to the fan 152, which is unducted, a ducted fan 184 is included aft of the fan 152, such that the engine 100 includes both a ducted and an unducted fan which both serve to generate thrust through the movement of air without passage through at least a portion of the turbomachine 120 (e.g., without passage through the HP compressor 128 and combustion section 120B for the embodiment depicted). The ducted fan 184 is rotatable about the same axis (e.g., the longitudinal axis 112) as the fan blade 154. The ducted fan 184 is, for the embodiment depicted, driven by the low pressure turbine 134 (e.g. coupled to the LP shaft 138). In the embodiment depicted, as noted above, the fan 152 may be referred to as the primary fan, and the ducted fan 184 may be referred to as a secondary fan. It will be appreciated that these terms “primary” and “secondary” are terms of convenience, and do not imply any particular importance, power, or the like.

The ducted fan 184 includes a plurality of fan blades arranged in a single stage, such that the ducted fan 184 may be referred to as a single stage fan. The fan blades of the ducted fan 184 can be arranged in equal spacing around the longitudinal axis 112. Each blade of the ducted fan 184 has a root and a tip and a span defined therebetween. As will be appreciated, a distance from the base of each fan blade of the ducted fan 184 to a tip of the respective fan blade is referred to as a span of the respective fan blade.

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan duct flowpath, or simply a fan duct 172. According to this embodiment, the fan flowpath or fan duct 172 may be understood as forming at least a portion of the third stream of the engine 100.

Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially-extending, circumferentially-spaced stationary struts 174 (only one shown in FIG. 1). The stationary struts 174 may each be aerodynamically contoured to direct air flowing thereby. Other struts in addition to the stationary struts 174 may be used to connect and support the fan cowl 170 and/or core cowl 122. In many embodiments, the fan duct 172 and the core duct 142 may at least partially co-extend (generally axially) on opposite sides (e.g., opposite radial sides) of the core cowl 122. For example, the fan duct 172 and the core duct 142 may each extend directly from a leading edge 144 of the core cowl 122 and may partially co-extend generally axially on opposite radial sides of the core cowl 122.

The engine 100 also defines or includes an inlet duct 180. The inlet duct 180 extends between an engine inlet 182 and the annular core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a fan duct splitter or leading edge 144 of the core cowl 122. The inlet duct 180 is wider than the core duct 142 along the radial direction R. The inlet duct 180 is also wider than the fan duct 172 along the radial direction R. The ducted fan 184 is positioned at least partially in the inlet duct 180. Airflow from the fan 152 is split between a bypass passage 194 and the inlet duct 180. Airflow from the ducted fan 184 is split between the fan duct 172 and the core duct 142 by the leading edge 144.

Notably, for the embodiment depicted, the engine 100 includes one or more features to increase an efficiency of a third stream thrust, Fn_{3S} (e.g., a thrust generated by an airflow through the fan duct 172 exiting through the fan exhaust nozzle 178, generated at least in part by the ducted fan 184). In particular, the engine 100 further includes an array of inlet guide vanes 186 positioned in the inlet duct 180 upstream of the ducted fan 184 and downstream of the engine inlet 182. The array of inlet guide vanes 186 are arranged around the longitudinal axis 112. For this embodiment, the inlet guide vanes 186 are not rotatable about the longitudinal axis 112. Each inlet guide vanes 186 defines a central blade axis (not labeled for clarity), and is rotatable about its respective central blade axis, e.g., in unison with one another. In such a manner, the inlet guide vanes 186 may be considered a variable geometry component. One or more actuators 188 are provided to facilitate such rotation and therefore may be used to change a pitch of the inlet guide vanes 186 about their respective central blade axes. However, in other embodiments, each inlet guide vanes 186 may be fixed or unable to be pitched about its central blade axis.

Further, located downstream of the ducted fan 184 and upstream of the fan duct inlet 176, the engine 100 includes an array of outlet guide vanes 190. As with the array of inlet guide vanes 186, the array of outlet guide vanes 190 are not rotatable about the longitudinal axis 112. However, for the embodiment depicted, unlike the array of inlet guide vanes 186, the array of outlet guide vanes 190 are configured as fixed-pitch outlet guide vanes.

Further, it will be appreciated that for the embodiment depicted, the fan exhaust nozzle 178 of the fan duct 172 is further configured as a variable geometry exhaust nozzle. In such a manner, the engine 100 includes one or more actuators 192 for modulating the variable geometry exhaust nozzle. For example, the variable geometry exhaust nozzle may be configured to vary a total cross-sectional area (e.g., an area of the nozzle in a plane perpendicular to the longitudinal axis 112) to modulate an amount of thrust generated based on one or more engine operating conditions (e.g., temperature, pressure, mass flowrate, etc. of an airflow through the fan duct 172). A fixed geometry exhaust nozzle may also be adopted.

The combination of the array of inlet guide vanes 186 located upstream of the ducted fan 184, the array of outlet guide vanes 190 located downstream of the ducted fan 184, and the fan exhaust nozzle 178 may result in a more efficient generation of third stream thrust, Fn_{3S}, during one or more engine operating conditions. Further, by introducing a variability in the geometry of the inlet guide vanes 186 and the fan exhaust nozzle 178, the engine 100 may be capable of generating more efficient third stream thrust, Fn_{3S}, across a relatively wide array of engine operating conditions, including takeoff and climb (where a maximum total engine thrust Fn_{Total}, is generally needed) as well as cruise (where a lesser amount of total engine thrust, Fn_{Total}, is generally needed).

Moreover, referring still to FIG. 1, in exemplary embodiments, air passing through the fan duct 172 may be relatively cooler (e.g., lower temperature) than one or more fluids utilized in the turbomachine 120. In this way, one or more heat exchangers 196 may be positioned in thermal communication with the fan duct 172, specifically in the third stream. For example, one or more heat exchangers 196 may be disposed within the fan duct 172 and utilized to cool one or more fluids from the core engine with the air passing through the fan duct 172, as a resource for removing heat from a fluid, e.g., compressor bleed air, oil or fuel.

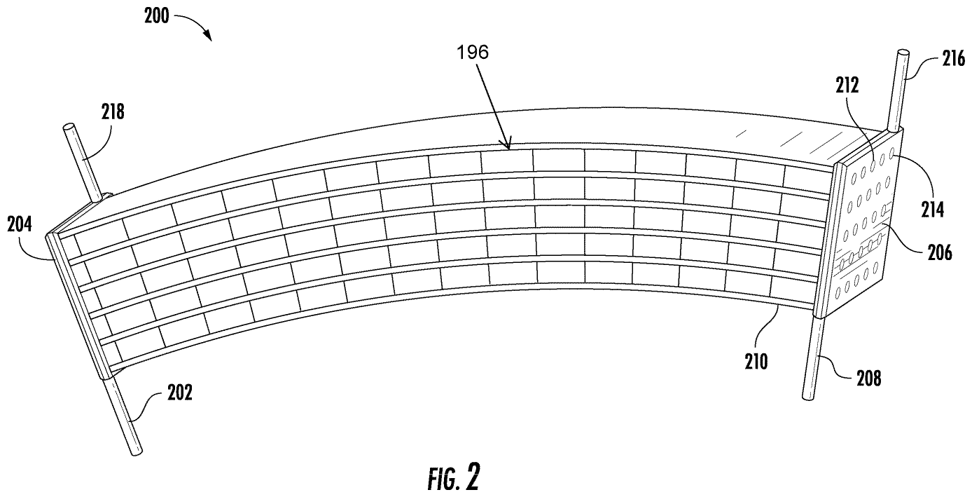

Referring to FIG. 2, a perspective schematic view of an exemplary heat exchanger system 200 for a gas turbine engine 100 is shown. The heat exchanger system 200 includes a heat exchanger 196 including a coolant inlet 202, an inlet manifold 204, an outlet manifold 206, a coolant outlet 208, at least one plate 210 extending from the inlet manifold 204 to the outlet manifold 206, a plurality of coolant channels 212 extending from the inlet manifold 204 to the outlet manifold 206, a plurality of bypass channels 214 extending from the inlet manifold 204 to the outlet manifold 206, a heated fluid inlet 216, and a heated fluid outlet 218.

The inlet manifold 204 receives a coolant (such as oil) from the coolant inlet 202 and transmits the fluid to the plate through the coolant channels 212. The coolant flows through the coolant channels 212 to the outlet manifold 206. As the coolant flows through the coolant channels 212, the coolant heats the plate 210, and air passing over the plate 210 absorbs heat from the heated plate. When the coolant reaches the outlet manifold 206, the coolant has cooled, and the outlet manifold 206 transmits the fluid out of the heat exchanger 196 through the coolant outlet 208.

When coolant in the heat exchanger 196 is congealed, a heated fluid is provided from the heated fluid inlet 216 to the bypass channels 214 to decongeal the heat exchanger 196. Specifically, as described in further detail below, a heated fluid such as air, fuel, a coolant, or supercritical carbon dioxide is provided to the bypass channels 212 from the heated fluid inlet 216 to the heated fluid outlet 218, transferring heat to the plate 210 and to the coolant congealed in the coolant channels 212. As the coolant in the coolant channels 212 heats, the viscosity of the coolant decreases, allowing the coolant to flow out from the coolant channels 212 into the outlet manifold 206 and through the coolant outlet 208.

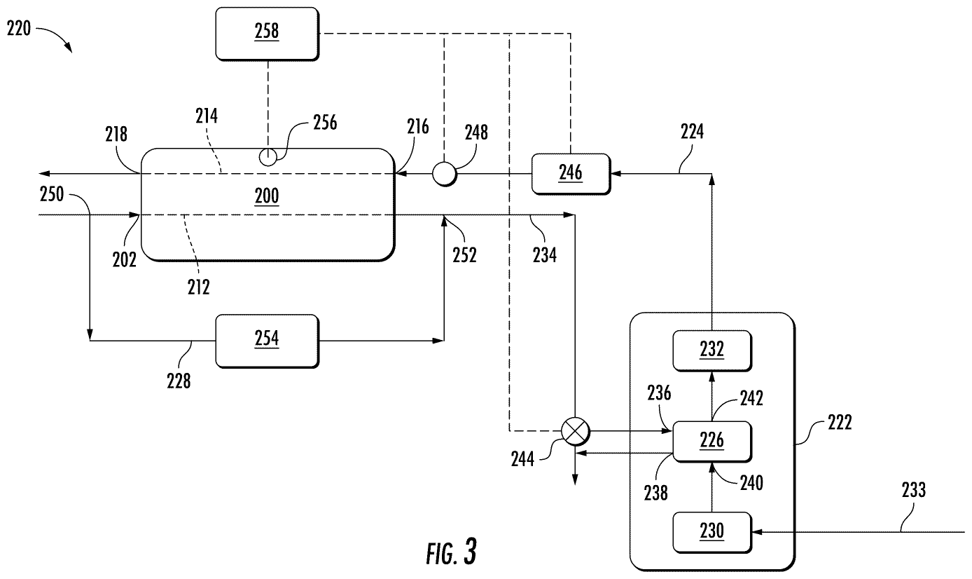

With reference to FIG. 3, an exemplary decongealing assembly 220 for a heat exchanger system 200 is shown. Specifically, a schematic view of the decongealing assembly 220 and the heat exchanger 196 is shown. The decongealing assembly 220 is configured to decongeal coolant in the heat exchanger 196.

The decongealing assembly 220 includes a fluid sink 222, a fluid line 224 fluidly connecting the fluid sink 222 to the heat exchanger 196, an assembly heat exchanger 226, and a bypass line 228. The fluid line 224 is fluidly connected to the heated fluid inlet 216 of the heat exchanger 196 to provide a heated fluid from the fluid sink 222 to the bypass channels 214.

As described above, the decongealing assembly 220 includes the fluid sink 222. The fluid sink 222 stores a fluid (such as air, fuel, supercritical carbon dioxide, or the like) that is heated with the assembly heat exchanger 226 to become a heated fluid. In particular, the fluid sink 222 may include a first chamber 230 in which the fluid is stored and provided to the assembly heat exchanger 226 and a second chamber 232 that stores the heated fluid output by the assembly heat exchanger 226. The fluid sink 222 provides the heated fluid from the assembly heat exchanger 226 to the bypass channels 214 of the heat exchanger 196 via the fluid line 224, decongealing the coolant in the coolant channels 212. In such a form, the fluid sink 222 is a heated fluid source for the decongealing assembly 220. The fluid sink 222 receives the fluid from an external fluid line 233.

The assembly heat exchanger 226 is configured to heat the fluid in the fluid sink 222 with heated coolant from the heat exchanger 196. Specifically, the decongealing assembly 220 includes an outlet line 234 downstream of the heat exchanger 196 that transmits heated coolant from the heat exchanger 196. The assembly heat exchanger 226 includes a first fluid inlet 236 in fluid communication with the outlet line 234, a first fluid outlet 238, a second fluid inlet 240 in fluid communication with the first chamber 230, and a second fluid outlet 242 in fluid communication with the second chamber 232. The assembly heat exchanger 226 receives the heated coolant from the outlet line 234, transfers heat from the heated coolant to the fluid from the first chamber 230 to form the heated fluid and transmits the heated fluid to the second chamber 232, which provides the heated fluid to the fluid line 224. Alternatively, the assembly heat exchanger 226 may provide the heated fluid directly to the fluid line 224. A coolant valve 244 controls flow from the outlet line 234 to the assembly heat exchanger 226.

The decongealing assembly 220 may include a pump 246. The pump 246 is configured to provide the heated fluid from the fluid sink 222 through the fluid line 224 to the bypass channels 214. More specifically, the pump 246 may be actuated to draw the heated fluid from the fluid sink 222 to the heated fluid inlet 216, which then flows into the bypass channels 214 to decongeal the coolant in the coolant channels 212. Once the coolant is no longer congealed, the pump 246 may be actuated to remove the heated fluid from the bypass channels 214. It will be appreciated that the decongealing assembly 220 may not include the pump 246 when the heated fluid may remain in the bypass channels 214, such as when the heated fluid is air.

The decongealing assembly 220 may include a valve 248 configured to control flow of the heated fluid from the fluid line 224 to the heated fluid inlet 216 and the bypass channels 214. When the valve 248 is open, the heated fluid flows through the fluid line 224 to the bypass channels 214 to decongeal the coolant in the coolant channels 212. When the valve 248 is closed, the heated fluid is blocked from the heated fluid inlet 216, preventing flow of the heated fluid into the bypass channels 214 when the coolant in the heat exchanger 196 is not congealed. The valve 248 may be any suitable type, such as a solenoid valve.

The bypass line 228 allows heated coolant to bypass the heat exchanger 196 to be provided directly to the fluid sink 222 and the assembly heat exchanger 226. More specifically, the bypass line 228 extends from a first location 250 upstream of a coolant inlet 202 of the heat exchanger 196 to a second location 252 downstream of an outlet of the heat exchanger 196. Bypassing the heat exchanger 196 allows the bypass line 228 to provide the heated coolant to the outlet line 234 and the assembly heat exchanger 226 without flowing through the coolant channels 212, which may include congealed coolant that would otherwise slow or block flow of the heated coolant. The decongealing assembly 220 may include a bypass valve 254 that controls flow through the bypass line 228.

The decongealing assembly 220 further comprises one or more sensors 256 configured to collect data about the coolant and the heat exchanger 196. In FIG. 3, one sensor 256 is shown, and it will be appreciated that more than one sensor 256 may be included in the decongealing assembly 220. More specifically, the one or more sensors 256 collect data that indicate whether the coolant in the heat exchanger 196 has congealed. As an example, the data collected by the one or more sensors 256 may include one or more of viscosity data of the coolant, a flow rate of the coolant from the inlet manifold 204 to the outlet manifold 206, a pressure change between the inlet manifold 204 and the outlet manifold 206, a temperature gradient across the heat exchanger 196, a temperature of a metal component of the heat exchanger 196 (such as a support structure or one of the plates 210), or combinations thereof. That is, the one or more sensors 256 may include one or more of a temperature sensor, a viscosity sensor, a pressure sensor, or a flow rate sensor.

The decongealing assembly 220 may include a controller 258 configured to provide the heated fluid to the bypass channels 214 based on the data collected by the one or more sensors 256. Specifically, the controller 258 may be a dedicated control module with a processor and a memory, or the controller may be part of an engine control system, such as a FADEC. The controller 258 is configured to determine, from the collected data, whether the coolant has congealed in the coolant channels 212. When the coolant has congealed, the controller 258 is configured to actuate the pump 246 and the valve 248 to provide the heated fluid from the fluid sink 222 to the bypass channel 214. When the collected data indicate that the coolant is no longer congealed, the controller 258 is configured to remove the heated fluid from the bypass channels 214, such as by actuating the pump 246 and/or the valve 248. The controller 258 may further be configured to actuate the coolant valve 244 to provide coolant to the assembly heat exchanger 226.

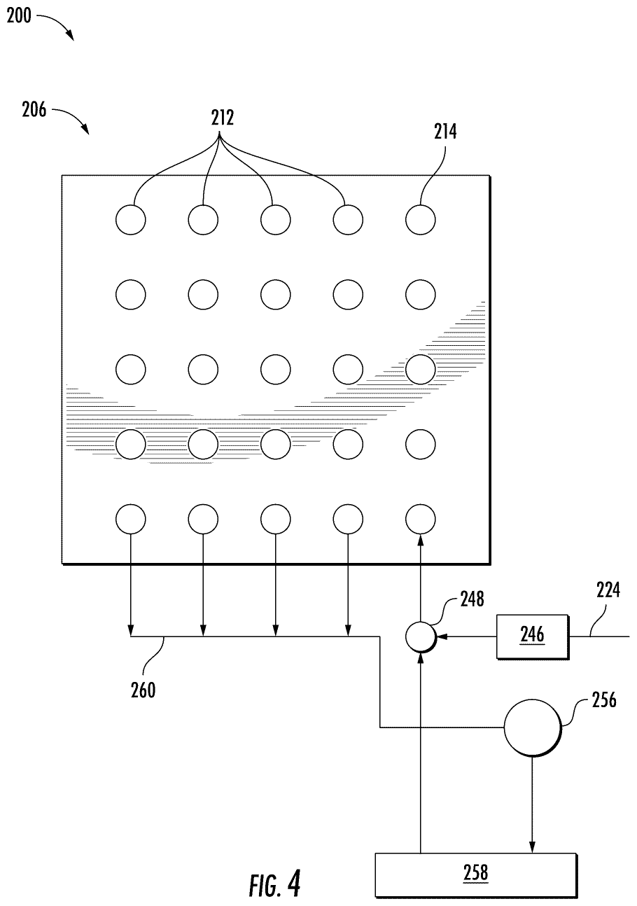

With reference to FIG. 4, a cross-sectional view of the outlet manifold 206 of the heat exchanger 196 is shown. More specifically, exemplary coolant channels 212 and bypass channels 214 are illustrated with the controller 258, one of the one or more sensors 256 (here, “the sensor 256”), and the valve 248 configured to control flow through the bypass channels 214. The coolant channels 212 and the bypass channels 214 of FIG. 4 are substantially the same size (such as a cross-sectional area) and cross-sectional shape, allowing substantially the same amount of fluid to flow therethrough. Specifically, the coolant channels 212 and the bypass channels 214 of FIG. 4 have circular cross-sections. When the heated fluid flows through the bypass channels 214, heat from the heated fluid flows to the adjacent coolant channel 212, increasing the temperature of the congealed fluid therein. As additional heat is provided to the coolant channels 212 by the heated fluid in the bypass channels 214, the coolant in the coolant channels 212 farther from the bypass channel begins to heat, and the viscosity of the coolant in the coolant channels 212 decreases. The coolant then flows out from the coolant channels 212 into the outlet manifold 206. The bypass channels 214 are shown as a single column of channels adjacent to the coolant channels 212, and it will be appreciated that the coolant channels 212 and the bypass channels 214 may a different arrangement, such as alternating columns, alternating rows, the bypass channels 214 being a first row of channels, the bypass channels 214 interleaved with the coolant channels 212, or combinations thereof.

The controller 258 is configured to actuate the valve 248 based on data from the sensor 256. In FIG. 4, the sensor 256 is a pressure sensor that collects data 260 about the pressure of the coolant in the coolant channels 212. The pressure of the coolant is indicative of the temperature and the viscosity of the coolant, and the controller 258 can determine whether the coolant is congealed based on the pressure data. Upon determining that the coolant is congealed, the controller 258 can open the valve 248 to provide the heated fluid from the fluid line 224 to the bypass channels 214. Upon collecting further pressure data that indicate that the coolant is no longer congealed, the controller 258 can close the valve 248 to cease flow of the heated fluid from the fluid line 224 to the bypass channels 214. To reduce or inhibit congealing of the heated fluid in the bypass channels 214 (such as when the heated fluid is a coolant or a fuel), the controller 258 can actuate the pump 246 to evacuate some or all of the heated fluid remaining in the bypass channels 214. Alternatively, the controller 258 may close the valve 248 without evacuating the heated fluid from the bypass channels 214 when the heated fluid is a gas (such as when the heated fluid is air or supercritical carbon dioxide) that does not congeal.

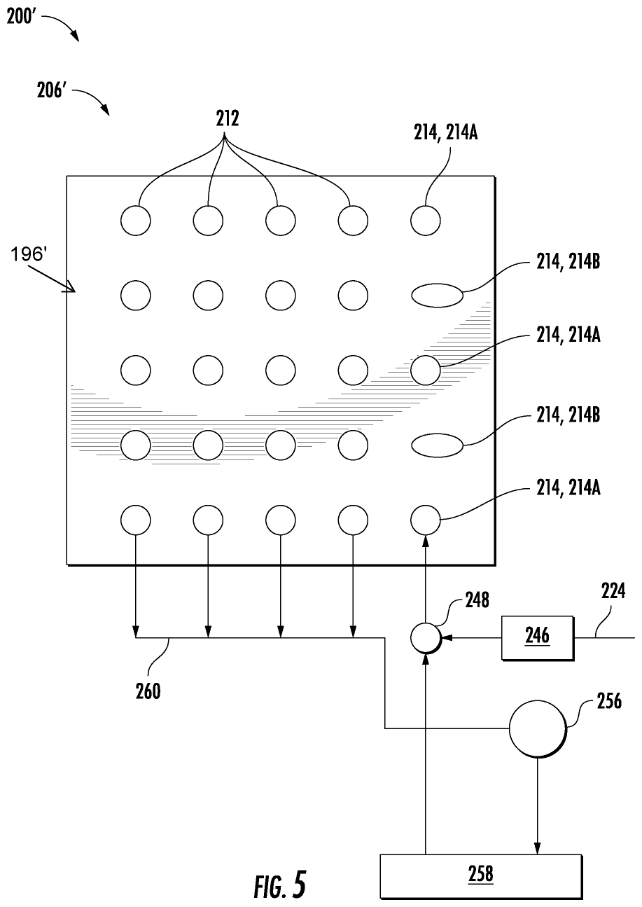

Now referring to FIG. 5, a cross-sectional view of an outlet manifold 206′ of another heat exchanger 196′ is shown. As with the heat exchanger 196 of FIG. 4, the outlet manifold 206′ includes a plurality of coolant channels 212 and a plurality of bypass channels 214. A controller 258 collects data from a sensor 256 and actuates a valve 248 to allow heated fluid through the bypass channels 214. It will be appreciated that similar numbers indicate similar components and features.

At least some of the bypass channels 214 of FIG. 5 have a different cross-sectional shape and a different cross-sectional area than the coolant channels 212. More specifically, at least some of the bypass channels 214 have a respective cross-sectional area that is greater than the respective cross-sectional areas of the coolant channels 212. In particular, the bypass channels 214 include first bypass channels 214A and second bypass channels 214B. The first bypass channels 214A have respective cross-sectional areas that are substantially equal to the respective cross-sectional areas of the coolant channels 212. The second bypass channels 214B have respective cross-sectional areas that are larger than the respective cross-sectional areas of the coolant channels 212. Because the second bypass channels 214B have greater cross-sectional areas than the first bypass channels 214A, a greater volume of the heated fluid can flow through the second bypass channels 214B than through the first bypass channels 214A, providing more heat to the coolant channels 212 adjacent to the second bypass channels 214B.

Additionally, the second bypass channels 214B may have a different shape than the coolant channels 212. In FIG. 5, the coolant channels 212 and the first bypass channels 214A have circular shapes, and the second bypass channels 214B have elliptical shapes. The elliptical shapes of the second bypass channels 214B allow more fluid to flow through the second bypass channels 214B while remaining within the volume the respective plate 210 (FIG. 2) to which the second bypass channels 214B are connected. It will be appreciated that the second bypass channels 214B may have a different shape, such as a rectangular shape, a trapezoidal shape, or any other polygonal or curved shape.

In FIG. 5, the coolant channels 212 are shown having a same cross-sectional size and shape. However, it will be appreciated that the coolant channels 212 may also have different cross-sectional sizes and/or cross-sectional shapes to allow different amounts of coolant to flow therethrough. For example, at least some of the coolant channels 212 may have an elliptical cross-sectional shape (not shown in the Figures).

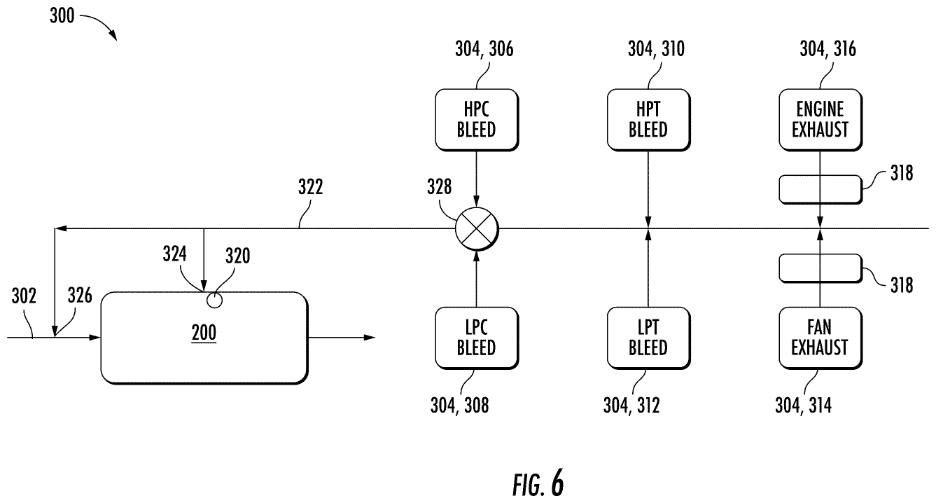

With reference to FIG. 6, a schematic view of another heat exchanger system 300 is shown. The heat exchanger system 300 includes a decongealing assembly 301 and the heat exchanger 196. The decongealing assembly 301 provides heated air to the heat exchanger 196 or a location upstream of the heat exchanger 196, such as a coolant line 302 or in the fan duct 172, to decongeal the coolant. Specifically, the decongealing assembly 301 flows the heated air across an exterior portion of the heat exchanger 196 or the coolant line 302, impinging the heat exchanger 196 or the coolant line 302 to transfer heat from the heated air to the congealed coolant. The decongealing assembly 301 may flow the heated air directly onto the heat exchanger 196 or may provide the heated air to the location upstream of the heat exchanger 196, such as in the fan duct 172.

The decongealing assembly 301 includes a heated fluid source 304. The heated fluid source 304 may be any component of the engine 100 where air is heated, and a portion of the heated air may be extracted to decongeal the heat exchanger 196. In FIG. 6, the heated fluid source 304 may be at least one of a compressor bleed, an exhaust, a turbine bleed, an air turbine starter exhaust, hot sump air, or a cross-engine bleed. A “compressor bleed” is a fluid line that extracts heated air from one of the HP compressor (an “HPC bleed” 306) or the LP compressor (an “LPC bleed” 308), such as between two stages of the HP compressor or the LP compressor. A “turbine bleed” is a fluid line that extracts heated air from one of the HP turbine (an “HPT bleed” 310) or the LP turbine (an “LPT bleed” 312). The “exhaust” may be a region within of the fan duct 172, downstream of the LP turbine, or downstream of the HP turbine (a “fan exhaust” 314) or a region downstream of the combustion section where exhaust gases from the engine 100 generally accumulate (an “engine exhaust” 316). The heated fluid source 304 may include one or more of the components, each providing heated air to decongeal the heat exchanger 196. The decongealing assembly 301 may include one or more filters 318 downstream of the heated fluid source that removes particulates from the air, such as soot from the exhaust.

The decongealing assembly 301 includes a sensor 320 configured to collect data about a coolant in the heat exchanger 196. As with the sensor of FIG. 3, the sensor 320 collects data that indicate whether the coolant in the heat exchanger 196 has congealed. As an example, the data collected by the sensor 320 may include one or more of viscosity data of the coolant, a flow rate of the coolant from the inlet manifold 204 to the outlet manifold 206 (FIG. 2), a pressure change between the inlet manifold 204 and the outlet manifold 206 (FIG. 2), a temperature gradient across the heat exchanger 196, a temperature of a metal component of the heat exchanger 196, or combinations thereof. That is, the sensor 320 may be a temperature sensor, a viscosity sensor, a pressure sensor, or a flow rate sensor.

The decongealing assembly 301 includes a fluid outlet 322 arranged to impinge the heat exchanger 196 or the coolant line 302 with the heated fluid. The fluid outlet 322 is arranged such that the heated fluid flows onto the heat exchanger 196 at a first outlet 324 or the coolant line 302 at a second outlet 326, providing convective heat transfer to the congealed coolant. The fluid outlet 322 may include a nozzle or other flow restrictor to increase a speed of the heated air out through the first or second outlets 324, 326, impinging the heat exchanger 196 or the coolant line 302.

The decongealing assembly 301 may include a valve 328 configured to combine fluid flows from a plurality of heated fluid sources 304. As described above, several components of the engine 100 may provide the heated air, and the valve 328 may combine two or more fluid flows from the components into a single combined flow of the heated air. In the example of FIG. 6, the HPC bleed 306 and the LPC bleed 308 are provided directly to the valve 328, while the HPT bleed 310, the LPT bleed 312, the engine exhaust 316, and the fan exhaust 314 are combined upstream of the valve 328. It will be appreciated that different combinations of the heated fluid sources 304 may be combined with the valve 328 or combined upstream of the valve 328.

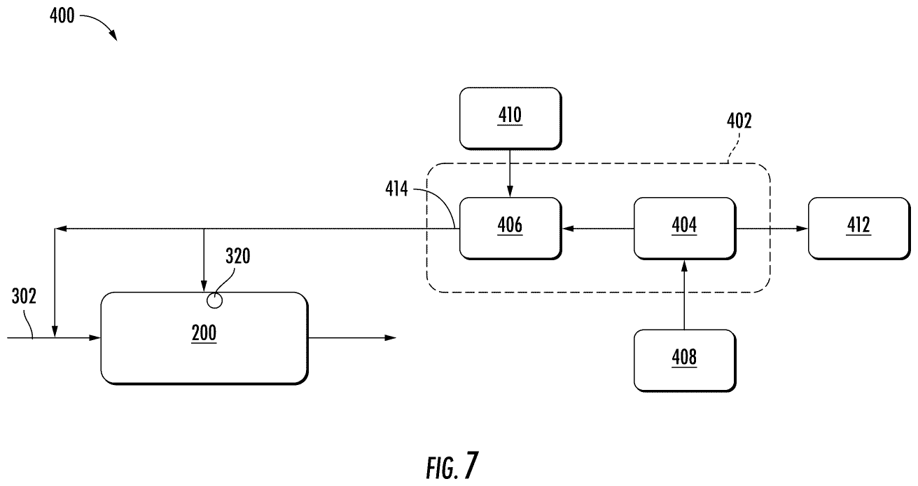

Now referring to FIG. 7, another heat exchanger system 400 is shown. The heat exchanger system includes a decongealing assembly 401 and the heat exchanger 196. Specifically, the decongealing assembly 401 of FIG. 7 provides heated air with a vortex tube and eductor system (“VES”) 402. The VES 402 includes a vortex tube 404, an eductor 406, a main fluid 408, a motive fluid 410, and an exhaust 412. As will be described in greater detail below, the vortex tube 404 receives the main fluid 408 and drives the main fluid 408 to both the exhaust 412 and to the eductor 406. The main fluid 408 flowing to the eductor 406 is hotter than the main fluid 408 flowing out to the exhaust 412. The eductor 406 drives the heated main fluid 408 with the motive fluid 410 to drive a combined heated fluid 414 to the heat exchanger 196, to the coolant line 302, or to a location upstream of the heat exchanger 196. That is, the VES 402 receives fluids 408, 410 from two sources (such as the heated fluid source described with respect to FIG. 6) and outputs a single stream of a combined heated fluid 414 that decongeals the coolant in the heat exchanger 196.

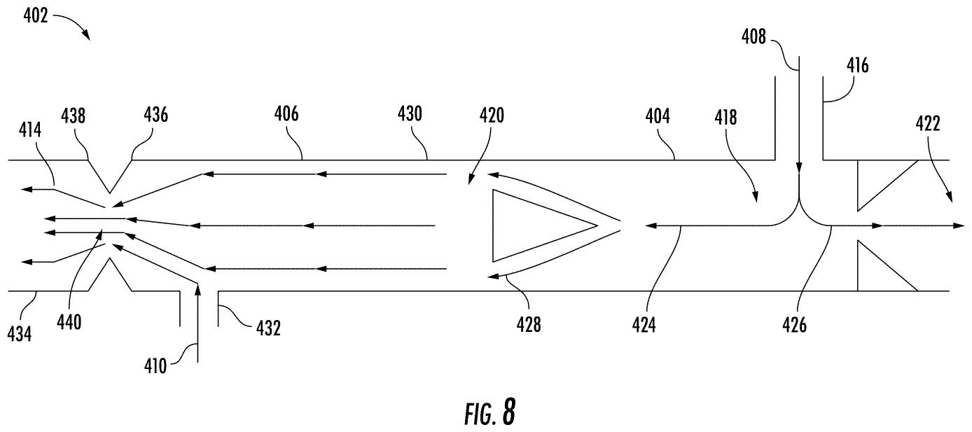

With reference to FIG. 8, the VES 402 is shown in greater detail. As described above, the VES 402 includes the vortex tube 404. The vortex tube 404 includes a main fluid inlet 416, a vortex region 418, a hot fluid outlet 420, and a cold fluid outlet 422. The main fluid inlet 416 in fluid communication with a heated fluid source 304, such as the HPC bleed 306, the LPC bleed 308, the HPT bleed 310, the LPT bleed 312, the fan exhaust 314, or the engine exhaust 316. The air from the heated fluid source 304 acts as the main fluid 408. When the main fluid 408 enters the main fluid inlet 416, the main fluid 408 enters the vortex region 418 and forms a vortex. A first portion 424 of the vortex moves axially toward the hot fluid outlet 420 and a second portion 426 of the vortex moves axially toward the cold fluid outlet 422. As the first portion 424 of the vortex moves axially, the first portion 424 of the vortex increases in temperature, forming a heated main fluid 428. The second portion 426 of the vortex, moving in the opposite direction of the first portion 424 of the vortex, increases in temperature by a smaller amount than the first portion 424. That is, the first portion 424 of the vortex is hotter than the second portion 426 of the vortex, and thus the hotter first portion 424 exits the hot fluid outlet 420 as the heated main fluid 428 to the eductor 406 while the colder second portion 426 exits the cold fluid outlet 422 to the exhaust 412 (FIG. 7).

The VES 402 includes the eductor 406. The eductor 406 includes a first fluid inlet 430, a second fluid inlet 432, and a combined fluid outlet 434. The first fluid inlet 430 (sometimes referred to as a “suction inlet”) is in fluid communication with the hot fluid outlet 420 of the vortex tube 404. The second fluid inlet 432 (sometimes referred to as a “motive inlet”) is in fluid communication with a source of the motive fluid 410. The source provides the motive fluid 410 to the eductor 406 that mixes with the heated main fluid 428 to form a combined heated fluid 414 that exits the combined fluid outlet 434. The motive fluid 410 may be a fluid from one of the heated fluid sources 304 described above.

The eductor 406 includes a converging nozzle 436, a diffuser 438, and a throat 440 connecting the converging nozzle 436 to the diffuser 438. The motive fluid 410 is provided to the second fluid inlet 432 to drive the heated main fluid 428 to the converging nozzle 436. The momentum from the motive fluid 410 in the second fluid inlet 432 causes a pressure decrease in the heated main fluid 428 from the first fluid inlet 430, driving additional heated main fluid 428 from the vortex tube 404 into the first fluid inlet 430. The converging nozzle 436 tapers inward toward the throat 440 such that the motive fluid 410 and the heated main fluid 428 are compressed in the converging nozzle 436 and begin to mix. The compression lowers the pressures of the motive fluid 410 and the main heated fluid 428 while increasing the speeds of the motive fluid 410 and the main heated fluid 428. The diffuser 438 tapers outward from the throat 440 such that, as the motive fluid 410 and the heated main fluid 428 pass through the throat 440 into the diffuser 438, the motive fluid 410 and the heated main fluid 428 mix and expand into the combined heated fluid 414. The speed of the combined heated fluid 414 drops while the pressure of the combined heated fluid 414 increases according to the Venturi effect. The combined heated fluid 414 then exits the combined fluid outlet 434 and flows to the heat exchanger 196 or the coolant line 302.

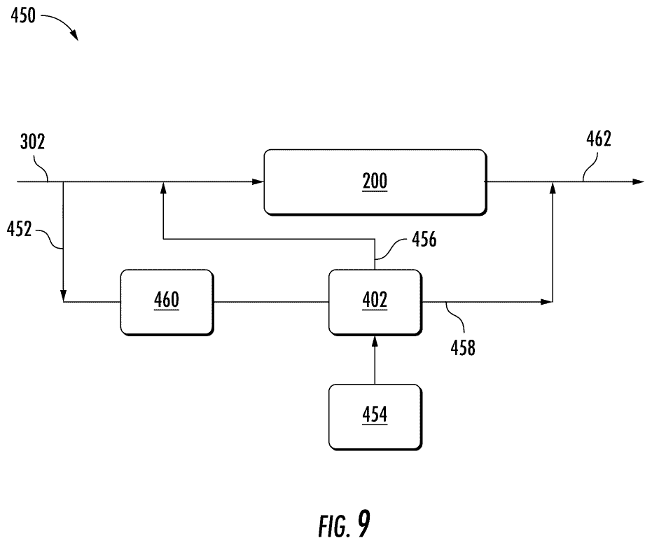

Now referring to FIG. 9, another heat exchanger system 450 is shown. The heat exchanger system 450 includes a decongealing assembly 451 and a heat exchanger 196. As with FIGS. 7-8, the decongealing assembly 451 includes a VES 402 that receives a main fluid 452 and a motive fluid 454 and outputs a heated combined fluid 456 and an exhaust fluid 458. Rather than using air as the main fluid 452, the VES 402 of FIG. 9 uses a coolant as the main fluid 452. A valve 460, such as a bypass valve 254 as shown in FIG. 3, controls flow of the coolant from a coolant line 302 to the VES 402. It will be appreciated that the VES 402 of FIG. 9 shares similar components to the VES 402 of FIG. 8, and such similar components will share similar numerals and will operate in similar ways.

The VES 402 generates a heated coolant as the first portion 424 of the vortex from the vortex tube 404 and the exhaust fluid 458 as the second portion 426 of the vortex from the vortex tube 404. The eductor 406 of the VES 402 combines the heated coolant with air as the motive fluid 454 to generate a coolant/air mixture as the heated combined fluid 456. The VES 402 provides the heated combined fluid 456 to the coolant line 302 upstream of the heat exchanger 196 and the exhaust fluid 458 to a second coolant line 462 downstream of the heat exchanger 196. In such a form, the heated combined fluid 456 has a higher temperature than the coolant input to the VES 402, which flows into the heat exchanger 196 to decongeal the coolant therein.

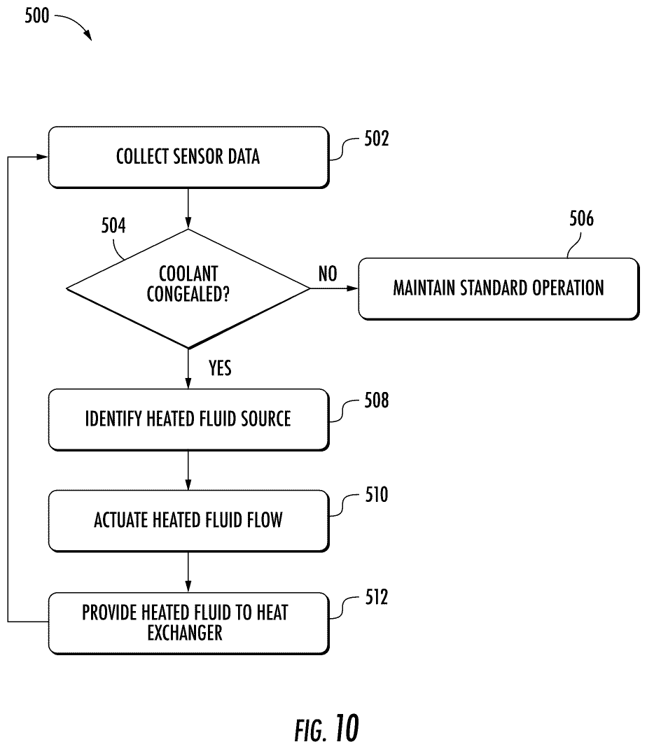

Referring now to FIG. 10, a flow diagram of a method 500 of decongealing a heat exchanger in accordance with an exemplary aspect of the present disclosure is provided. The method 500 may be utilized to decongeal the heat exchanger 196 shown in FIGS. 1-9. However, in other exemplary aspects, the method 500 may additionally or alternatively be utilized to decongeal other suitable heat exchangers.

As is depicted, the method 500 includes at (502) collecting data about the heat exchanger from one or more sensors. As described above, the collected data may include one or more of viscosity data of the coolant, a flow rate of the coolant from the inlet manifold to the outlet manifold, a pressure change between the inlet manifold and the outlet manifold, a temperature gradient across the heat exchanger, or a temperature of a metal component of the heat exchanger.

The method 500 at (504) includes determining whether coolant is congealed in the heat exchanger based on the collected data. A controller can determine whether the oil is congealed based on whether the collected data meet or exceed specific thresholds. As an example, the controller can determine that the coolant is congealed when the viscosity data exceed a viscosity threshold. As another example, the controller can determine that the coolant is congealed when the pressure change between the inlet manifold and the outlet manifold exceeds a pressure threshold. As another example, the controller can determine that the coolant is congealed when a flow rate of the coolant is below a flow rate threshold. As another example, the controller can determine that the coolant is not congealed when a period of time since actuating a decongealing assembly, as described below, exceeds a time threshold. If the coolant is congealed, the method 500 continues at (508). Otherwise, the method 500 continues at (506).

The method 500 at (506) includes maintaining standard operation of the heat exchanger in response to the determination at (504). Because the coolant is not congealed, the heat exchanger operates according to standard procedures, transferring heat from coolant for the engine. If the heated fluid has been provided to the heat exchanger, the flow of heated fluid ceases. Following (506), the method 500 returns to (502) to collect additional data.

The method 500 at (508) includes identifying a heated fluid source in response to the determination at (504). As described above, a decongealing assembly collects the heated fluid from one or more heated fluid sources to decongeal the coolant in the heat exchanger. The heated fluid source may include one or more of: a bleed from a component of the engine (such as a compressor, a turbine, or an exhaust), a fuel, supercritical carbon dioxide, air heated by a vortex tube and eductor system, a fluid sink, or combinations thereof.

The method 500 includes at (510) actuating flow of the heated fluid. As described above, the decongealing assembly can actuate one or more components to begin flow of the heated fluid. As an example, the decongealing assembly can open one or more valves from the components to bleed heated air. As another example, the decongealing assembly can actuate an assembly heat exchanger to heat fluid in the fluid sink. As another example, the decongealing assembly can actuate the vortex tube and the eductor to heat air.

The method 500 includes at (512) providing the heated fluid to the heat exchanger. As described above, the decongealing assembly can flow the heated fluid through bypass channels of the heat exchanger to decongeal the coolant. Alternatively, the decongealing assembly can impinge the heat exchanger with heated air. Yet alternatively, the decongealing assembly can impinge a coolant line upstream of the heat exchanger, heating the coolant therein, which then flows into the inlet manifold of the heat exchanger to decongeal the coolant. Following (512), the method 500 continues at (502) to collect additional data.

Further aspects are provided by the subject matter of the following clauses:

A heat exchanger system includes a heat exchanger including an inlet manifold, an outlet manifold, a coolant channel extending from the inlet manifold to the outlet manifold, and a bypass channel extending from the inlet manifold to the outlet manifold, the bypass channel being separate from the coolant channel and a decongealing assembly including a heated fluid source and a fluid line fluidly connecting the heated fluid source to the bypass channel.

The heat exchanger system of any of the preceding clauses, wherein the decongealing assembly further includes an assembly heat exchanger configured to heat fluid in the heated fluid source with heated coolant from the heat exchanger.

The heat exchanger system of any of the preceding clauses, further including an outlet line downstream of the heat exchanger, wherein the assembly heat exchanger includes a first fluid inlet in fluid communication with the outlet line, a first fluid outlet, a second fluid inlet in fluid communication with the heated fluid source, and a second fluid outlet in fluid communication with the fluid line.

The heat exchanger system of any of the preceding clauses, wherein the decongealing assembly further includes a pump fluidly connected to the fluid line and to the bypass channel.

The heat exchanger system of any of the preceding clauses, wherein the bypass channel has a cross-sectional area that is greater than a cross-sectional area of the coolant channel.

The heat exchanger system of any of the preceding clauses, further including a valve between the bypass channel and the fluid line.

The heat exchanger system of any of the preceding clauses, wherein the decongealing assembly further includes a bypass line extending from a first location upstream of an inlet of the heat exchanger to a second location downstream of an outlet of the heat exchanger.

The heat exchanger system of any of the preceding clauses, wherein the heated fluid is one of a coolant, a fuel, air, or supercritical carbon dioxide.

The heat exchanger system of any of the preceding clauses, wherein the decongealing assembly further includes a sensor configured to collect data about a coolant in the coolant channel of the heat exchanger and a controller configured to provide the heated fluid to the bypass channel based on the collected data.

The heat exchanger system of any of the preceding clauses, wherein the controller is configured to actuate a pump to provide the heated fluid from the heated fluid source to the bypass channel when the collected data indicate that the coolant has congealed in the coolant channel and to remove the heated fluid from the bypass channel when the collected data indicate that the coolant is no longer congealed in the coolant channel.

The heat exchanger system of any of the preceding clauses, wherein the controller is configured to actuate a valve to open the bypass channel.

The heat exchanger system of any of the preceding clauses, wherein the data collected by the sensor include at least one of: viscosity data of the coolant, a flow rate of the coolant from the inlet manifold to the outlet manifold, a pressure change between the inlet manifold and the outlet manifold, a temperature gradient across the heat exchanger, or a temperature of a metal component of the heat exchanger.

A method for decongealing a heat exchanger, the method including receiving data indicative that a coolant is congealed in a coolant channel extending through the heat exchanger, providing a heated fluid from a heated fluid source to the heat exchanger, receiving second data indicative that the coolant in the coolant channel is no longer congealed, and ceasing flow of the heated fluid from the heated fluid source.

The method of any of the preceding clauses, further including providing the heated fluid to a bypass channel of the heat exchanger, the bypass channel being separate from the coolant channel.

The method of any of the preceding clauses, wherein the bypass channel is adjacent to a coolant channel including the coolant, wherein the heated fluid in the bypass channel is configured to decongeal the coolant in the coolant channel.

The method of any of the preceding clauses, further including, after ceasing flow of the heated fluid from the heated fluid source, actuating a pump to remove the heated fluid from the bypass channel.

The method of any of the preceding clauses, further including heating a fluid with an assembly heat exchanger in the heated fluid source and outputting the heated fluid to the heat exchanger.

The method of any of the preceding clauses, wherein the assembly heat exchanger is configured to heat the fluid with a heated coolant from an outlet line downstream of the heat exchanger.

The method of any of the preceding clauses, wherein providing the heated fluid from the heated fluid source to the heat exchanger further includes actuating a valve to connect a bypass line to a bypass channel of the heat exchanger, the bypass line extending from a first location upstream of an inlet of the heat exchanger to a second location downstream of an outlet of the heat exchanger.

The method of any of the preceding clauses, wherein the heated fluid is a heated coolant and the bypass line is connected to the bypass channel to provide the heated coolant to the bypass channel.

A system includes a heat exchanger, a heated fluid source, a sensor configured to collect data about a coolant in the heat exchanger, and a decongealing assembly arranged to provide heated fluid from the heated fluid source to one of the heat exchanger or a location upstream of the heat exchanger based on the data collected by the sensor.

The system of any of the preceding clauses, wherein the heated fluid source is at least one of a compressor bleed, an exhaust, or a turbine bleed.

The system of any of the preceding clauses, wherein the decongealing assembly includes a vortex tube having an inlet, a hot fluid outlet, and a cold fluid outlet, the inlet in fluid communication with the heated fluid source and the hot fluid outlet in fluid communication with the heat exchanger.

The system of any of the preceding clauses, wherein the heated fluid source is a coolant line upstream of the heat exchanger, the heated fluid is the coolant in the coolant line, and the inlet of the vortex tube is in fluid communication with the coolant line.

The system of any of the preceding clauses, wherein the cold fluid outlet is in fluid communication with a second coolant line downstream of the heat exchanger.

The system of any of the preceding clauses, wherein the heated fluid is heated air, the heated fluid source is one of a compressor bleed, an exhaust, or a turbine bleed, and the inlet of the vortex tube is in fluid communication with the one of the compressor bleed, the exhaust or the turbine bleed.

The system of any of the preceding clauses, further including an eductor including a first fluid inlet, a second fluid inlet, and a combined fluid outlet, the first fluid inlet in fluid communication with the heated fluid source, and the combined fluid outlet in fluid communication with the heat exchanger.

The system of any of the preceding clauses, further including a filter between the heated fluid source and the heat exchanger.

The system of any of the preceding clauses, wherein the decongealing assembly includes an eductor including a first fluid inlet, a second fluid inlet, and a combined fluid outlet, wherein the first fluid inlet is in fluid communication with the heated fluid source and the combined fluid outlet in fluid communication with the heat exchanger.

The system of any of the preceding clauses, wherein the second fluid inlet is in fluid communication with a second heated fluid source.

The system of any of the preceding clauses, wherein the heat exchanger is disposed in a third stream of a gas turbine engine.

The system of any of the preceding clauses, wherein the decongealing assembly further includes a valve configured to combine fluid flows from the heated fluid source and a second heated fluid source.

A method for decongealing a heat exchanger, the method including receiving data indicative that a coolant is congealed in a coolant channel extending through the heat exchanger, providing, to the heat exchanger or to a location upstream of the heat exchanger, heated air from a heated fluid source that is a component of a gas turbine engine, receiving second data indicative that the coolant is no longer congealed, and ceasing flow of the heated air from the heated fluid source.

The method of any of the preceding clauses, wherein the heated fluid source is at least one of a compressor bleed, an exhaust, or a turbine bleed.

The method of any of the preceding clauses, wherein providing the heated air from the heated fluid source further includes impinging the heat exchanger with the heated air.

The method of any of the preceding clauses, wherein providing the heated air from the heated fluid source further includes providing the heated air to an eductor as a motive fluid for flowing a heated coolant.

The method of any of the preceding clauses, wherein the heated fluid source is a vortex tube.

The method of any of the preceding clauses, further including filtering the heated air from the heated fluid source prior to providing the heat exchanger or the location upstream of the heat exchanger with the heated air.

The method of any of the preceding clauses, wherein the data and the second data include at least one of: viscosity data of the coolant, a flow rate of the coolant through the heat exchanger, a pressure change across the heat exchanger, a temperature gradient across the heat exchanger, or a temperature of a metal component of the heat exchanger.

The method of any of the preceding clauses, further including combining the heated air from the heated fluid source with heated air from a second heated fluid source into a combined heated air flow and providing the combined heated air flow to the heat exchanger or the location upstream of the heat exchanger.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A system, comprising:
a heat exchanger;
a heated fluid source configured to generate a heated fluid;
a sensor configured to collect data about a coolant in the heat exchanger; and
a decongealing assembly arranged to provide the heated fluid from the heated fluid source to one of the heat exchanger or a location upstream of the heat exchanger based on the data collected by the sensor, wherein the decongealing assembly comprises a first chamber, an assembly heat exchanger upstream from the first chamber, and a second chamber upstream from the assembly heat exchanger, and wherein the heated fluid is different from the coolant.

2. The system of claim 1, wherein the heated fluid source is at least one of a compressor bleed, an exhaust, or a turbine bleed.

3. The system of claim 1, wherein the decongealing assembly includes a vortex tube having an inlet, a hot fluid outlet, and a cold fluid outlet, the inlet in fluid communication with the heated fluid source and the hot fluid outlet in fluid communication with the heat exchanger.

4. The system of claim 3, wherein the heated fluid source is a coolant line upstream of the heat exchanger, the heated fluid is the coolant in the coolant line, and the inlet of the vortex tube is in fluid communication with the coolant line.

5. The system of claim 4, wherein the cold fluid outlet is in fluid communication with a second coolant line downstream of the heat exchanger.

6. The system of claim 3, wherein the heated fluid is heated air, the heated fluid source is one of a compressor bleed, an exhaust, or a turbine bleed, and the inlet of the vortex tube is in fluid communication with the one of the compressor bleed, the exhaust or the turbine bleed.

7. The system of claim 3, further comprising an eductor including a first fluid inlet, a second fluid inlet, and a combined fluid outlet, the first fluid inlet in fluid communication with the heated fluid source, and the combined fluid outlet in fluid communication with the heat exchanger.

8. The system of claim 1, further comprising a filter between the heated fluid source and the heat exchanger.

9. The system of claim 1, wherein the decongealing assembly includes an eductor including a first fluid inlet, a second fluid inlet, and a combined fluid outlet, wherein the first fluid inlet is in fluid communication with the heated fluid source and the combined fluid outlet in fluid communication with the heat exchanger.

10. The system of claim 9, wherein the second fluid inlet is in fluid communication with a second heated fluid source.

11. The system of claim 1, wherein the heat exchanger is disposed in a stream that extends from a compressor section to a rotor assembly flowpath of a gas turbine engine.

12. The system of claim 1, wherein the decongealing assembly further comprises a valve configured to combine fluid flows from the heated fluid source and a second heated fluid source.

13. A method for decongealing a heat exchanger, the method comprising:
receiving data indicative that a coolant is congealed in a coolant channel extending through the heat exchanger;
providing, to the heat exchanger or to a location upstream of the heat exchanger, heated air from a heated fluid source that is a component of a gas turbine engine;
receiving second data indicative that the coolant is no longer congealed; and
ceasing flow of the heated air from the heated fluid source.

14. The method of claim 13, wherein the heated fluid source is at least one of a compressor bleed, an exhaust, or a turbine bleed.

15. The method of claim 13, wherein providing the heated air from the heated fluid source further comprises impinging the heat exchanger with the heated air.

16. The method of claim 13, wherein providing the heated air from the heated fluid source further comprises providing the heated air to an eductor as a motive fluid for flowing a heated coolant.

17. The method of claim 13, wherein the heated fluid source is a vortex tube.

18. The method of claim 13, further comprising filtering the heated air from the heated fluid source prior to providing the heat exchanger or the location upstream of the heat exchanger with the heated air.

19. The method of claim 13, wherein the data and the second data include at least one of: viscosity data of the coolant, a flow rate of the coolant through the heat exchanger, a pressure change across the heat exchanger, a temperature gradient across the heat exchanger, or a temperature of a metal component of the heat exchanger.

20. The method of claim 13, further comprising combining the heated air from the heated fluid source with heated air from a second heated fluid source into a combined heated air flow and providing the combined heated air flow to the heat exchanger or the location upstream of the heat exchanger.
